(19) United States
(12) Patent Application Publication
(10) Pub. No.: US 2019/0281881 A1
(43) Pub. Date: Sep. 19, 2019

(54) SYSTEM AND METHOD FOR PROCESSING PIECES OF PROTEIN

(71) Applicants: Daniel B. Stauft, III, Liberty Township, OH (US); Oliver D. Gildersleeve, III, Cambridge City, IN (US); Mark Edward Auernheimer, Richmond, VA (US); Jeffrey D. Cowles, St. Simons Island, GA (US); Zachary Shepard, Cincinnati, OH (US); Jeffrey H. Shutte, New Carlisle, OH (US)

(72) Inventors: Daniel B. Stauft, III, Liberty Township, OH (US); Oliver D. Gildersleeve, III, Cambridge City, IN (US); Mark Edward Auernheimer, Richmond, VA (US); Jeffrey D. Cowles, St. Simons Island, GA (US); Zachary Shepard, Cincinnati, OH (US); Jeffrey H. Shutte, New Carlisle, OH (US)

(73) Assignee: Sugar Creek Packing Co., Washington Court House, OH (US)

(21) Appl. No.: 16/433,560

(22) Filed: Jun. 6, 2019

Related U.S. Application Data
(63) Continuation-in-part of application No. 16/003,933, filed on Jun. 8, 2018.
Application No. 16/003,933 is a continuation-in-part of application No. 15/462,484, filed on Mar. 17, 2017, now Pat. No. 10,292,409.
Application No. 15/462,484 is a continuation-in-part of application No. 15/398,385, filed on Jan. 4, 2017.
(60) Provisional application No. 62/405,645, filed on Oct. 7, 2016.

(51) Int. Cl. A23P 20/15; B65B 5/06; B65B 25/06; B65B 25/22; B65B 47/02; A23L 13/00; A23L 13/50; A23L 17/00; A23L 5/10

(52) U.S. Cl. CPC A23P 20/15; B65B 5/067; B65B 25/065; B65B 25/064; B65B 25/061; A23V 2002/00; B65B 47/02; A23L 13/03; A23L 13/57; A23L 17/75; A23L 5/11; B65B 25/22

(57) ABSTRACT

A system for processing pieces of protein includes an optional flour applicator that applies a coating of flour, and optionally seasoning, to uncooked protein pieces; an optional seasoning applicator that applies a coating of seasoning on the uncooked protein pieces; a packaging machine that receives uncooked protein pieces, optionally coated with flour and/or seasoning, and retains the optionally coated, uncooked protein pieces in pouches; a batter applicator that deposits a batter made from flour containing gluten directly into the cooking pouches; the packaging machine programmed to vacuum seal the cooking pouches, thereby coating the uncooked protein pieces with the batter in the cooking pouches to make batter-coated uncooked protein pieces; and a heating unit programmed to completely cook the batter-coated protein pieces in the pouches for a time and temperature selected to completely cook the protein pieces and leave the batter sufficiently tacky to adhere to breading.

### TECHNICAL FIELD

The present disclosure relates to systems and methods for processing protein, and more particularly, to systems and methods for preparing batter-coated protein pieces of meat, poultry, and fish for frying.

### BACKGROUND

Fried protein, which frequently takes the form of fried chicken pieces or fried fish pieces, is a popular food. Consequently, restaurants, especially fast food and fast casual restaurants, provide such fried protein dishes on a large volume basis. Preparation of such fried protein dishes in restaurants requires that the food preparer at the restaurant handle raw protein pieces to coat the protein pieces in a batter, bread the batter-coated protein pieces, and then fry the protein pieces both to cook them and to harden the batter coating, typically to a firm or crispy crust. Many processes for frying protein pieces require the protein pieces to be coated, by dredging or immersion, with liquid batter that may include raw egg and/or other ingredients that may spoil at room temperature, or if kept too long in a refrigerated state, which may constitute a source of hygiene problems for the restaurant. In addition, coating uncooked protein pieces prior to frying creates a risk of the protein spoiling if allowed to remain at room temperature too long, or if refrigerated for too long.

Accordingly, there is a need for a system and process for preparing fried protein dishes in a manner that minimizes the chance of contamination from using batter that inadvertently may have spoiled. There is also a need for a process and system for preparing fried protein dishes that can be performed by relatively unskilled preparers, and which eliminates the need for a food preparer to handle raw, uncooked protein pieces when coating the protein pieces and when frying them. Further, there is a need for a system and process for preparing fried protein dishes that allows broad culinary options to be employed in the final preparation step.

### SUMMARY

The present disclosure describes systems and methods for processing pieces of unfrozen, uncooked protein, such as animal protein, which includes meat, such as beef, pork, poultry, and fish. Exemplary embodiments of the systems and methods are particularly useful for processing boneless protein in the form of strips, tenders, nuggets, and chunks, as well as fish filets. The uncooked protein pieces are optionally initially dusted, for example with flour. In an exemplary embodiment, a system for processing pieces of protein includes a packaging machine that receives uncooked protein pieces and retains the uncooked protein pieces in cooking pouches; a batter applicator that deposits a batter made from flour containing gluten into the cooking pouches; and the packaging machine is programmed to seal the uncooked protein pieces in the cooking pouches, thereby coating the uncooked protein pieces with the batter, forming coated, uncooked protein pieces.

In embodiments, uncooked protein pieces are crust frozen in a freezer unit and one or more of the protein pieces are placed into individual pouches in a packaging machine with a high-gluten batter. The depth of crust-freezing the protein pieces is sufficient to make the protein pieces dimensionally stable, which facilitates their subsequent handling, including placement in the pouches and accepting the batter coating evenly and completely over their entire outer surfaces.

The sealing process, which in embodiments is a vacuum sealing process, facilitates the even and complete coating of the outer surfaces of the protein pieces with the batter. The batter-coated protein pieces are then fully cooked in-bag, in embodiments sous vide cooked, and thereafter are chilled or frozen for storage and/or later shipment to an end user.

The end user simply removes the previously battered and cooked protein pieces from their pouches. If necessary, the protein pieces are thawed. The batter becomes tacky again when thawed, or remains tacky if the battered protein pieces are only chilled, so the end user need only apply breading and/or other coating to the tacky batter coating the protein pieces as desired, and flash fry the pieces for serving. The optional initial step of dusting the protein pieces, which may be with flour, facilitates adhesion of the batter to the outer surfaces of the protein pieces, especially if the outer surfaces of the protein pieces are moist or wet.

In embodiments, the batter coating the protein pieces is a high-gluten batter selected to provide a coating that remains tacky and can accept breading and other coatings after the protein pieces are fully cooked in their pouches. If the cooked battered protein pieces are frozen in their pouches, when the battered cooked protein pieces are later thawed for final preparation, the original batter coating again becomes tacky. This property of the batter eliminates the need for batter coating the protein pieces at the point of frying, or batter coating the protein pieces a second time, to adhere breading at the point of frying, which reduces the likelihood of contamination of the protein pieces by the batter and streamlines the food preparation process at the point of final preparation for service. The disclosed systems and methods also provide a precooked protein product to a food preparer that reduces the occurrence of spoiled protein pieces.

In another embodiment, a system for processing pieces of protein includes an optional flour applicator that applies a coating of flour, and optionally seasoning, to uncooked protein pieces; an optional seasoning applicator that applies a coating of seasoning on the uncooked protein pieces; a packaging machine that receives uncooked protein pieces, optionally coated with flour and/or seasoning, and retains the optionally coated, uncooked protein pieces in cooking pouches; a batter applicator that deposits a batter made from a flour containing gluten directly into the cooking pouches; the packaging machine programmed to vacuum seal the optionally coated, uncooked protein pieces, thereby coating the optionally coated, uncooked protein pieces with the batter in the cooking pouches to make batter-coated uncooked protein pieces; and a heating unit programmed to sous vide cook the batter-coated, uncooked protein pieces in the cooking pouches for a time and temperature selected to completely cook the protein pieces and leave the batter sufficiently tacky to adhere to breading.

In yet another embodiment, a method for processing protein pieces includes placing uncooked protein pieces in cooking pouches; depositing a batter made from flour containing gluten, and optionally egg, milk, buttermilk, seasonings, soy or fish meal, meat-meal, nut meal, legume-flour, pea-flour or mixtures thereof, in the cooking pouches either before or after placing the uncooked protein pieces in the cooking pouches; and sealing the uncooked protein pieces in the cooking pouches, thereby resulting in coated uncooked protein pieces.

In still another embodiment, a food processing line for processing pieces of protein includes a packaging machine in an environmentally separated preparation room that receives uncooked protein pieces and retains the uncooked protein pieces in cooking pouches, and a batter applicator that deposits a batter made from flour containing gluten directly into the cooking pouches, wherein the packaging machine is programmed to seal the uncooked protein pieces, thereby forming battered uncooked protein pieces sealed in the cooking pouches; and an environmentally separated cooking room containing a heating unit that receives the sealed cooking pouches from the packaging machine and completely cooks the battered pieces of protein while in the cooking pouches at a temperature and time selected to completely cook the protein pieces, whereby the batter is sufficiently tacky such that breading can adhere thereto.

Other objects and advantages of the disclosed system and method for processing pieces of protein will be apparent from the following description, the accompanying drawings, and the appended claims.

### BRIEF DESCRIPTION OF THE DRAWINGS

FIG. 1 is a schematic representation of an embodiment of the disclosed system for cooking pieces of protein;

FIG. 2 is a perspective view of pieces of protein sealed by the packaging machine of the system of FIG. 1 into individual bags or pouches, showing a separated individually sealed piece of protein in a bag or pouch;

FIG. 3 is a flow chart showing an embodiment of the disclosed method for cooking pieces of protein of the system of FIG. 1;

FIG. 4 is a schematic representation of another embodiment of the disclosed system for cooking pieces of protein; and

FIG. 5 is a flow chart showing another embodiment of the disclosed method for cooking pieces of protein, pertaining to the system of FIG. 4.

### DETAILED DESCRIPTION

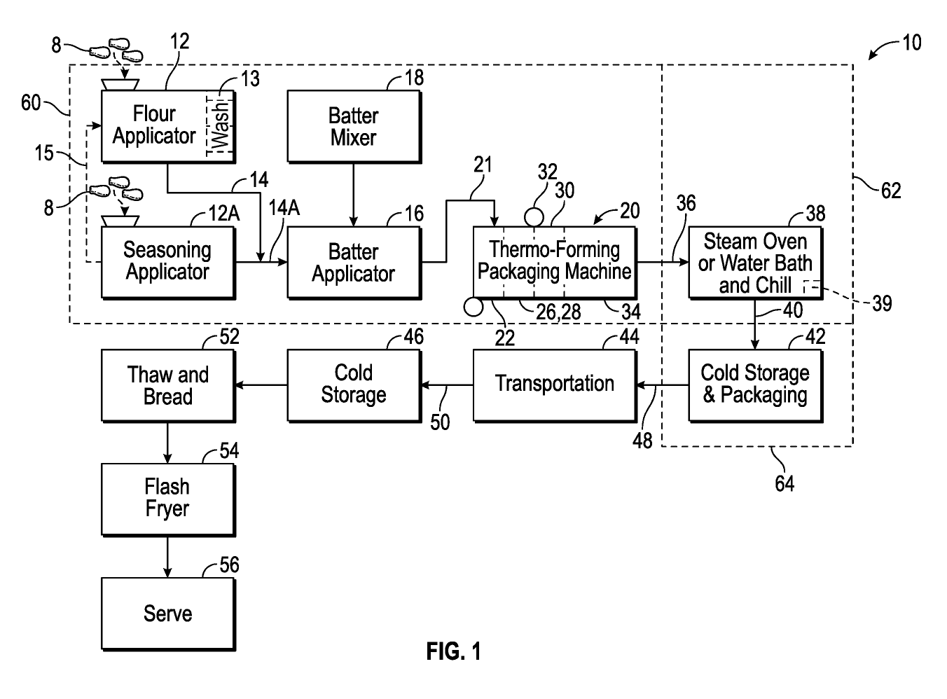

As shown in FIG. 1, an exemplary embodiment of the system, generally designated 10, for cooking pieces of protein may include a flour applicator 12 that receives the pieces of protein 8 in an uncooked state (i.e., raw) and applies a coating of flour to outer surfaces thereof. The flour applicator 12 may receive uncooked protein pieces 8 via a conveyor (not shown), or the uncooked protein pieces may be fed or loaded manually into the flour applicator, which may include a hopper that receives the protein pieces. In embodiments, the protein pieces 8 may be animal protein, and may include whole-muscle, intact chicken pieces, other types of poultry, such as turkey and duck, or other protein such as beef, ground beef patties, pork, and whole (i.e., unshredded) fish pieces. In other embodiments, the protein may take the form of formed pieces of meat, shredded chicken, other poultry, and fish.

The flour applicator 12 may take the form of a flour duster unit, such as manufactured by Spooner Vicars of Wigan, United Kingdom, and the Alco Preduster Type ABM, manufactured by Alco-Food-Machines GmbH & Co. KG of Bad Iburg, Germany. In still other embodiments, the flour applicator 12 may take the form of a manual flour application station, a tumbler unit, and a shaker unit. The flour applicator 12 may apply flour selected from all-purpose flour, rice flour, pea flour, sorghum flour, high-gluten wheat flour, high-protein wheat flour, nut flour, soy powder, milk powder, whey powder, and mixtures thereof. The flour applicator 12 may apply any of the foregoing types of flour, or mixtures thereof, further mixed with a seasoning or seasonings selected from salt, pepper, spice or spices, flavorings, extracts, and mixtures thereof. The dusting of flour to the outer surfaces of the uncooked protein pieces 8 may facilitate or enhance the subsequent coating of the uncooked protein pieces with high-gluten batter, as will be described.

In an embodiment, the flour applicator 12 may be connected to a wash or sprayer 13 that receives the uncooked protein pieces 8 coated with flour from the flour applicator 12 and applies a layer of liquid to the outer surfaces of the uncooked protein pieces. The liquid may be selected from egg wash, egg wash substitute, oil, milk, and mixtures thereof. The sprayer 13 may be a disc sprayer, such as The Bakon USA Disc Spraying-Eggwash Sprayer manufactured by Bakon USA Food Equipment of Torrance, Calif. In other embodiments, the sprayer 13 may be selected from a spray coater and a mist coater, such as a Mistcoater SST, manufactured by Automatic Process Equipment Corp. of Lake Odessa, Mich.

In another embodiment, the flour applicator 12 receives the uncooked protein pieces 8, and applies a coating or dusting of flour on the outer surfaces of the protein pieces. The flour-coated uncooked protein pieces 8 then may be transported, either manually or by a conveyor, to the sprayer 13, where they may be sprayed with a liquid to form a liquid coating over the flour dusting layer on the outer surfaces of the uncooked protein pieces. The uncooked protein pieces 8 then may be sent through the flour applicator 12 a second time to apply a second coating or dusting of flour on the outer surfaces of the uncooked protein pieces.

Optionally, the system 10 may include a seasoning applicator 12A. The seasoning applicator 12A itself may receive the uncooked protein pieces 8, which may be by way of a conveyor (not shown) or manual loading received in a hopper, and apply a coating of seasoning on the outer surfaces of the protein pieces. The seasoning may be selected from salt, pepper, spice or spices, flavorings, extracts, and mixtures thereof. The seasoning applicator 12A may be selected from a vacuum tumbler that tumbles the protein pieces 8 with under a vacuum, a drum tumbler, and a tumble mixer. In an embodiment, the seasoning applicator 12A applies seasoning to the outer surfaces of the uncooked protein pieces 8 and in the system 10 is connected to apply the seasoning to the uncooked protein pieces prior to the protein pieces entering the flour applicator 12. In that embodiment, flour applicator 12 may receive seasoned uncooked protein pieces 8 from the seasoning applicator 12A and apply a coating of flour to outer surfaces thereof.

The system 10 may include an optional conveyor 15 that conveys the uncooked protein pieces from the seasoning applicator 12A to the flour applicator 12. The conveyor 15 may be an integral component of the seasoning applicator 12A. Alternately, the protein pieces 8 seasoned by the seasoning applicator 12A may be conveyed manually, as by trays, from the seasoning applicator to the flour applicator 12. In still other embodiments, the seasoning applicator 12A and the flour applicator 12 may be integrated into a single unit.

The uncooked protein pieces 8, dusted with a layer flour by the flour applicator 12, and optionally sprayed with a layer of liquid by wash or sprayer 13, may be conveyed from the flour applicator to the batter applicator by a first conveyor 14, or conveyed manually, such as by trays, to a batter applicator 16. In the embodiment where the uncooked protein pieces 8 are coated with a liquid by the sprayer 13, the batter applicator 16 may receive the uncooked protein pieces 8 from the sprayer, and in still other embodiments, the batter applicator may receive the uncooked protein pieces first coated with the flour, then with the layer of liquid, and finally with the second coating of flour on the outer surfaces thereof. Optionally, the batter applicator 16 may receive uncooked protein pieces 8 directly from the seasoning applicator 12A, either manually, as by trays, or by a conveyor 14A.

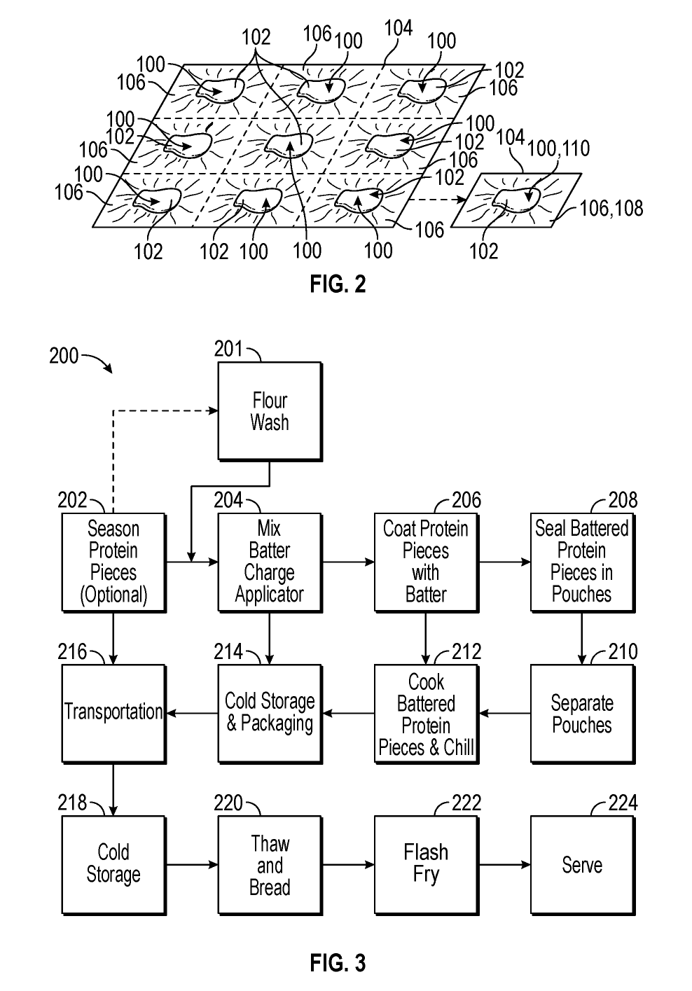

The batter applicator 16 may apply a batter 102 (see FIG. 2) made from high-gluten flour to the coated outer surfaces of the uncooked protein pieces 8, making battered uncooked protein pieces 100 (see FIG. 2). In an embodiment, the batter applicator 16 may include or consist of a BatterPro batter applicator manufactured by Nothum Food Processing Systems of Springfield, Mo., or any one or more various batter applicators, such as those manufactured by John Bean Technologies Corp. of Chicago, Ill., including the Heritage XL, APB, Rotary Drum, and T-1 models. Optionally, the batter applicator 16 may be supplied by batter from a batter mixer 18, such as a batter mixer manufactured by Nothum Food Processing Systems of Springfield, Mo. Alternatively, the batter applicator 16 may apply batter to the dusted, uncooked protein pieces 8 by dipping or drench/waterfall, and may take the form of conveyor-style, rotary drum, or batter-breading equipment. Alternatively, the application of batter to the protein pieces 8 may be done manually.

In embodiments, the batter 102 may include a mixture of flour and water, and in certain embodiments, the flour may consist of, or include, a high-gluten flour mixed with water because it will remain sticky or tacky until fried. In more specific embodiments, the flour may be selected to have between approximately 12% to 25% gluten. A high-gluten flour (often used for bread flour) that may be used is typically approximately 12% to 15% gluten. In still other embodiments, a batter made from flour of greater than approximately 15% gluten may be used.

The water-to-flour mixture for the high-gluten batter 102 may be in the range of approximately 60% water to 40% flour by volume, which may be preferred for chicken. A ratio of approximately 70% water to 30% flour by volume may be preferable for dryer proteins. Batter made from water-to-flour ratios between these two ratios also may be acceptable. In embodiments, a water-to-flour ratio of as high as 88% water to 15% water may be functional. It is preferable to use a relatively sticky, high-gluten flour. In embodiments, it may be desirable to add egg white, egg, milk, buttermilk, seasonings, soy, fish meal, meat-meal, nut meal, legume-flour, pea-flour, or other proteins, or mixtures of the foregoing, to the batter, but such additional ingredients are optional and not essential to the effectiveness of the disclosed system and method.

The system 10 also may include a packaging machine, generally designated 20, that receives the battered uncooked protein pieces 100 from the batter applicator 16 and seals the battered uncooked protein pieces in plastic pouches 106 (see FIG. 2). In an embodiment, the packaging machine 20 may take the form of a thermoforming packaging machine that vacuum seals the uncooked, battered protein pieces 100 in the plastic pouches 106. The battered uncooked protein pieces 100 may be conveyed to the packaging machine 20 by a second conveyor 21, and/or manually by carrying trays of battered uncooked protein pieces to the packaging machine. A typical thermoforming packaging machine 20 that may be employed in the system 10 is a Multivac R 530, manufactured by MULTIVAC Sepp Haggenmüller SE & Co. KG. Such a thermoforming packaging machine 20 may include a forming station 22 that receives a lower web 24 of formable sheet plastic from a roll and forms or shapes the plastic sheet by the effects of heat, compressed air and vacuum. The food-grade plastic may be selected to be heat sealable and able to withstand food cooking temperatures, such as for sous vide or steam cooking, which may range from 140° F. to 170° F. or higher, depending upon the type of protein cooked.

The pliable sheet of the lower web 24 may be conveyed to a loading area 26 of the thermoforming packaging machine 20 in which the sheet is placed into cavities on a tray shown schematically as 28 in FIG. 1. The battered uncooked protein pieces 100 are placed in the individual cavities of the tray 28 in the loading area 26, and the trays are moved to a sealing station 30 of the thermoforming packaging machine 20, where an upper web 32 of formable sheet plastic is applied on top of the lower web 24 and over the battered uncooked protein pieces 100. In an embodiment, the battered uncooked protein pieces 100 may be manually removed from the first conveyor 21 and placed into the cavities of the tray 28 of the thermoforming packaging machine 20, which may be lined with the lower web 24.

The upper and lower webs 24, 32 may be sealed hermetically to each other at the sealing station 30 by means of a seal seam to form the bags or pouches 106, each containing one or more battered uncooked protein pieces 100. The sealed bags or pouches 106 may be conveyed to a crosscutting and longitudinal cutting unit station 34 of the thermoforming packaging machine 20 where they are sliced into individual sealed plastic bags or pouches (see FIG. 2), each containing one or more battered uncooked protein pieces 100. In an embodiment, air may be evacuated from the bags or pouches 106 of battered uncooked protein pieces 100 by the thermoforming packaging machine 20 such that they are vacuum sealed. In other embodiments, air may not be evacuated from the bags or pouches 106 before sealing.

As shown in FIG. 2, the individual battered uncooked protein pieces 100, which are coated on their outer surfaces with layers of the high-gluten batter 102 over the dusting of flour and/or a layer of seasoning, may be hermetically sealed within heat seal seams 104 forming individual pouches 106 by the thermoforming packaging machine 20 (FIG. 1). In embodiments, a single piece of battered uncooked protein 100 is sealed in one or more of the pouches 106; in other embodiments, more than one piece of battered protein 100 is sealed in one or more of the pouches 106. Crosscutting and longitudinal cutting unit station 34 may cut the pouches 106 into individual sealed plastic bags or pouches 108 along heat seal seams 104. The terms “in-bag” and “in-pouch,” and “bag” and “pouch” each shall be used interchangeably herein.

As shown in FIG. 1, the battered uncooked protein pieces 100, sealed within the individual pouches 108 (FIG. 2), may be conveyed either manually and/or by a third conveyor 36 from the packaging machine to a heating unit, generally designated 38, that may take the form of a steam oven or a heated water bath. There, the sealed pouches 108 may be heated to cook the battered protein pieces 100 thoroughly in-pouch. Cooking temperatures may range from 140° F. to 170° F., depending upon the type of protein piece 8 cooked, and the desired texture of the protein. In one embodiment, the vacuum-formed, vacuum-sealed pouches 108 are sous vide cooked in either a steam oven or a hot water bath heating unit 38 that thoroughly and fully cooks the battered protein pieces 100 in-pouch. The temperatures and times of cooking will vary depending upon the specific type of protein to be cooked, the thickness of the battered protein pieces 100 and the type of heating unit 38 employed. In any event, the battered protein pieces 100 may be thoroughly and completely cooked sufficiently to meet food safety requirements for both private and public consumption. At the same time, the temperatures and times are selected to be below that which would harden the batter 102 coating the battered protein pieces 100.

After the in-pouch battered protein pieces 100 are thoroughly cooked, the battered cooked protein pieces 110 may be chilled. In embodiments, the battered cooked protein pieces 110 may be chilled to 40° F. The requisite chill temperature, chilling time, and the time interval between cooking and chilling the battered cooked protein pieces 110, may vary depending upon the type of protein to be chilled and United States Department of Agriculture (USDA) regulations. In embodiments, if the in-pouch cooked protein pieces 110 are cooked in a water bath, such as sous vide cooked, the cooked protein pieces may be chilled in a cold water bath in the same vessel 38. In other embodiments, such as where the heating unit 38 may take the form of a steam oven, the in-bag or in-pouch cooked protein pieces 110 may be chilled in a separate cold water bath or chilling apparatus 39, which may take the form of a tank of chilled water.

The chilled in-pouch cooked protein pieces 110 may be conveyed by a fourth conveyor 40, and/or in embodiments conveyed manually or by pallet moving equipment, to a cold storage 42. The cold storage 42 may maintain the cooked protein pieces 110 in individual pouches 108 chilled for intermediate storage duration, or alternatively, freeze the cooked battered protein pieces 110 in individual pouches 108 for longer term storage and subsequent transportation. In embodiments, the cold storage 42 may include packaging the individual in-pouch cooked protein pieces 110. Packaging may include placing predetermined numbers of the bags or pouches 108 in plastic totes, bulk boxes, and/or corrugated containers. Packing of the pouches or bags 108 may be performed either before or after freezing the chilled cooked battered protein pieces 110 in the cold storage 42. Further, the cooked and chilled battered protein pieces 110 may be flash frozen in the cold storage 42.

The cooked battered protein pieces 110, now frozen in individual pouches 108 and packaged, may be transported by a mechanism, schematically represented as 44, from the cold storage 42. The transportation mechanism 44 may take the form of a conveyor, a refrigerated truck, and/or an unrefrigerated delivery vehicle, the latter of which may require insulated containers for the bags or pouches 108. The bags or pouches 108 of frozen, cooked battered protein pieces 110 may be placed into the transportation vehicle 44 by a conveyor 48, and/or by hand-loading or loading with a loading device such as a pallet lifter or pallet truck (not shown).

When delivered to the destination remote food service facility, the containers of frozen in-bag cooked protein pieces 110 may be unloaded from the transportation vehicle 44 manually and/or by mechanical means, indicated schematically at 50, and may be stored in a destination cold storage facility or receptacle 46 that may be associated with an end user. The cold storage 46 may be a remote cold storage facility such as at a restaurant, including a fast food restaurant or a fast casual restaurant, or other food service provider. At the remote facility, when ready for consumption, a bag or bags 108 of frozen cooked protein pieces 110 may be unpacked and removed from the cold storage 46, and if necessary thawed, at which time the batter 102, because it is a high-gluten batter of the type described herein, again becomes tacky. If the bag or bags 108 of cooked protein pieces 110 are refrigerated or chilled, but not frozen, the batter 102 coating the cooked protein pieces already will be tacky. The cooked battered protein pieces 110 may be removed from their pouches 108 and hand rolled in breading or other coating, or tumbled in breading or other coating in a tumbler (not shown). The breading or other coating will adhere to the batter 102 coating of the cooked protein pieces 110 because it is tacky. Additional batter or other coating substances is not required at this point to get the breading or other coating to adhere to the cooked protein pieces 110.

In an embodiment, the breaded cooked protein pieces 110 then may be placed in a cooking device 54, such as a flash fryer. The flash fryer 54 may have cooking oil at a temperature of, or approximately, 400° F. or greater and the flash frying may take place for 90 seconds, or approximately 90 seconds. For larger protein pieces 110, for example a large, thick 9 oz. boneless breast portion cut from and 18 oz. chicken breast, or a large bone-in thigh, a cook temperature of approximately 325° F. to 350° F. for 150 seconds may be preferable. Cook temperatures may be from approximately 305° F. to 445° F. with multiple oil types, such as canola, vegetable shortening, cottonseed, beef tallow, and the like. In any event, the flash frying is at an oil temperature and for a time sufficient to harden the batter coating 102 and attach the second coating of breading or other particulate coating to the cooked protein piece 110, and to bring the previously cooked protein pieces 110 to serving temperature. The cooked protein pieces 110, now flash fried, are ready for serving as indicated block 56, which may be a serving table or individual plate.

In other embodiments, the cooking device 54 may take the form of a microwave oven, a convection oven, an infrared oven, or an oven with conventional resistance heating elements or gas burners. In still other embodiments, the cooking device 54 may be a skillet, a hot plate, an over-fired broiler, a chargrill, and a flat grill. In other embodiments, the cooked battered protein pieces 110 may be heated to serving temperature without breading, so that the batter coating 102 simply is hardened on the previously cooked battered protein pieces. The cooked battered protein pieces 110 also may be flash fried, then heated to serving temperature by one of the aforementioned methods, either before or after flash frying. Flash frying the cooked, battered, and breaded protein pieces 110 hardens the exterior of the protein piece and adheres the breading to the tacky batter coating 102.

In an embodiment, the system 10 for cooking pieces of protein may take the form of a food processing line that may include an environmentally separated preparation room 60 that contains the flour applicator 12, optionally the vacuum tumbler 12A, the batter applicator 16, the batter mixer 18, and the thermoforming packaging machine 20. The food processing line 10 also may include an environmentally separated cooking room 62 that contains the heating unit 38, which also may include a chill bath 39, and an environmentally sealed cold room 64 containing the cold storage 42. Each of the preparation room 60, the cooking room 62 and the cold room 64 may be environmentally separated, which may include individually atmospherically and structurally isolating them from the ambient environment and from each other to effectively prevent any contamination from occurring.

The first conveyor 14 may convey the uncooked protein pieces 8 from the flour applicator 12 to the batter applicator 16 in the preparation room 60. The second conveyor 21 may convey the uncooked pieces of protein 100 coated or battered with high-gluten flour from the batter applicator 16 to the thermoforming packaging machine 20 in the preparation room 60. The third conveyor 36 may convey the battered uncooked protein pieces 100, sealed in separated, individual plastic pouches 108, from the thermoforming packaging machine 20 in the preparation room 60 to the heating unit 38 in the cooking room 62. The fourth conveyor 40 may convey the cooked battered pieces of protein 110, sealed in separated plastic pouches 108, from the heating unit 38 in the cooking room 62 to the cold storage 42 in the cold room 64. The third conveyor 36 and fourth conveyor 40 may pass through the walls separating the preparation room 60 and the cooking room 62, and the cooking room and the cold room 64, respectively, through openings that restrict air passage between the rooms.

Thus, the flour applicator 12, optional vacuum tumbler 12A, batter applicator 16, and thermoforming packaging machine 20 may be series connected by the first conveyor 14, 14A and the second conveyor 21, respectively, in preparation room 60. The heating unit 38 may be series connected to the thermoforming packaging machine 20 by way of the third conveyor 36, and the cold storage 42 may be series connected to the heating unit 38 by way of the fourth conveyor 40. Thus, the vacuum tumbler 12, the first conveyor 14, the batter applicator 16, the second conveyor 21, the thermoforming packaging machine 20, the third conveyor 36, the heating unit 38, the fourth conveyor 40, and the cold storage 42 may be series connected in that order, as shown in FIG. 1.

As shown in FIG. 3, the foregoing system 10 provides a process 200 for cooking battered pieces of protein 100 that may be stored in a cold storage 42 and later breaded and flash fried without the addition of batter at the time of flash frying. As indicated in block 201, the process 200 may begin by loading uncooked protein pieces 8 (FIG. 1) into a flour applicator 12, which may be by batch mode or continuous mode, which applies coating of flour to outer surfaces of the protein pieces in an uncooked state. The step of block 201 optionally may include a step of mixing spices with the flour that is coated or dusted onto the uncooked protein pieces 8. Also as indicated in block 201, optionally, the uncooked protein pieces 8 may be washed by a wash or sprayer 13 that applies a layer of liquid to the outer surfaces of the uncooked protein pieces after applying the coating of flour. The liquid may be selected from egg wash, egg wash substitute, milk, oil, liquid flavoring, and mixtures thereof. Block 201 also may include a step of applying a second coating of flour to the outer surfaces of the uncooked protein pieces 8 after applying the layer of liquid.

As indicated in block 202, optionally, the process 200 may begin by placing uncooked protein pieces 8 in a seasoning applicator 12A, such as a vacuum tumbler (see FIG. 1) to coat the protein pieces 8 with seasoning. The process may continue with the seasoned uncooked protein pieces 8 being conveyed to the flour applicator 12 described in reference to block 201.

As shown in block 204, a high-gluten batter 102 may be prepared in the batter mixer 18, and the batter is charged into the batter applicator 16. As indicated in block 206, the uncooked protein pieces 8, which have been dusted by flour applicator 12 and optionally washed by sprayer 13, may be conveyed by the first conveyor 14 to the batter applicator 16 and coated with batter 102 in the applicator. Alternatively, uncooked protein pieces 8 may be placed directly into the batter applicator 16 and coated with batter 102 without having been seasoned, dusted with flour, or washed or sprayed. In embodiments, the process steps in blocks 201 and 204 may be performed sequentially in the order shown in FIG. 3, or performed simultaneously, or performed in reverse order shown. It also is within the scope of the disclosure to perform these and other steps of process 200 continuously and/or in batch mode.

As indicated in block 208, the uncooked battered protein pieces 100 may be conveyed by the second conveyor 21 to the thermoforming packaging machine 20, wherein the uncooked battered protein pieces are sealed, in embodiments vacuum sealed, in individual pouches 106 in a sheet, and are separated into individual pouches 108, as indicated in block 210. As indicated in block 212, the in-pouch cooked battered protein pieces 110 are conveyed by the third conveyor 36 to cooking device 38, such as a steam oven or heated water bath, where the battered protein pieces are thoroughly cooked in-pouch, such as by sous vide cooking. The cook temperature is below the temperature that would harden the high-gluten batter 102. After cooking, the in-pouch cooked and battered protein pieces 110 may be chilled, which may be in the chilled water bath 39, or the chilled water may be introduced into the same vessel used for the hot water bath that cooks the protein pieces 110.

As indicated in block 214, the in-bag or in-pouch cooked battered protein pieces 110, now chilled, may be stored in cold storage 42, in which they may be frozen or maintained chilled without freezing. At this time, the pouches 108 may be packaged in containers, such as totes, bulk boxes, and/or corrugated cases. The packaging of pouches 108 may take place after the chilling of the protein pieces 110 and either before or after freezing in the cold storage 42. Predetermined numbers of pouches 108 may be packaged in containers as desired, for example, to fulfill customer orders, or in predetermined assortments or groupings. As indicated in block 216, the packages of pouches 108 later may be transported to a restaurant or other food service facility by a vehicle 44.

As indicated in block 218, the containers of pouches 108 of frozen or chilled cooked battered protein pieces 110, may be stored in cold storage 46 at the point of delivery for use as needed by the restaurant or food service facility. As indicated in block 220, when needed, one or more pouches 108 of cooked battered protein pieces 110 may be unpacked from their containers, thawed or warmed, and the protein pieces removed from their pouches. If the pouches 108 have been chilled and not frozen, the batter 102 on the cooked protein pieces 110 is tacky when the cooked battered protein pieces are removed from their pouches. If the cooked battered protein pieces 110 have been frozen, the batter 102 will become tacky when the cooked battered protein pieces thaw. In either case, the cooked battered protein pieces 110 may be removed from their pouches 108, and because of the tacky coatings of batter 102 of high-gluten flour, breaded with a breading of choice, which may be selected from any number of predetermined breading formulations, without need of an additional coating of batter or other substance to make the breading adhere to the cooked battered protein pieces 110.

As indicated in block 222, the cooked battered protein pieces 110, now breaded, may be placed in a cooking device, such as the flash fryer 54, and flash fried to harden or make crisp the batter 102 and breading. Since the protein pieces 110 are already cooked, it is only necessary to flash fry the protein pieces sufficiently to harden the batter and warm the protein pieces to a predetermined serving temperature. As indicated in block 224, the flash fried protein pieces 110 then may be served to a consumer, who may be a patron of the restaurant.

The advantage of the process 200 is that it provides pre-cooked protein to a food service facility, such as a restaurant, which may be a fast food restaurant or a fast casual restaurant, so that the food service facility workers are relieved from handling raw or partially cooked protein, thereby minimizing the likelihood of contamination or spoilage of the protein or batter. At the same time, the protein pieces may be advertised as being hand breaded by the restaurant workers at the location of the restaurant. The flour applicator 12 may provide a light dusting of flour on the uncooked protein pieces 8 that may facilitate the adherence of the high gluten batter 102 to the uncooked protein pieces, especially if the uncooked protein pieces are moist on their outer surfaces.

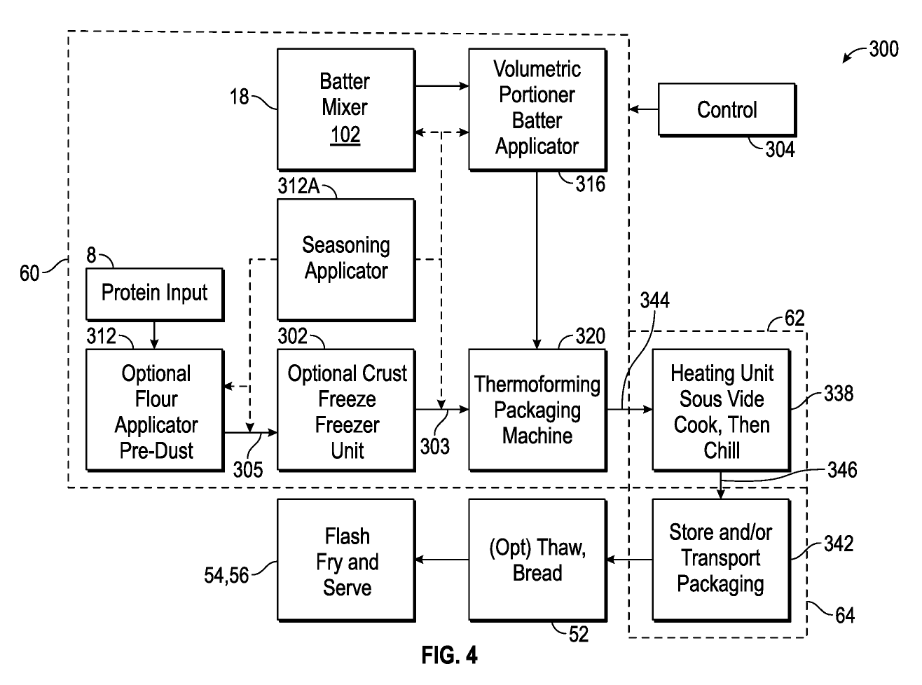

In another exemplary embodiment, shown in FIG. 4, a system for processing pieces of protein, generally designated 300, optionally includes a freezer unit 302 that receives the protein pieces 8 (see FIG. 1) in an unfrozen and uncooked state and crust freezes the protein pieces. As used herein, the term “crust frozen” means that the protein pieces 8 are subjected to cryogenic or subfreezing temperatures for a time sufficient to freeze the outer portions of the protein pieces to a predetermined depth, for example, several millimeters, while the interiors of the protein pieces beyond or beneath the predetermined depth remain unfrozen. In embodiments, the freezer unit 302 is selected from a tunnel freezer, a spiral freezer, and an immersion freezer.

A packaging machine 320, similar in type, construction, and operation to packaging machine 20 described with reference to FIG. 1, receives the uncooked protein pieces 8, optionally crust-frozen from the freezer unit 302, either manually or by a conveyor 303, and retains the pieces of uncooked protein pieces in cooking pouches 106 (see FIG. 2), which in embodiments may take the form of food grade plastic pouches or foil pouches. As described previously, the packaging machine may 320 take the form of the thermoforming packaging machine 20 shown in FIG. 1. In some embodiments, a single one of the uncooked protein pieces 8 is placed in an individual one of the pouches 106; in other embodiments, two or more uncooked protein pieces 8, optionally crust frozen, are placed in individual ones of the pouches 106.

In embodiments, a batter applicator 316 deposits predetermined, measured volumes or quantities of the batter 102 (see FIG. 2), which is made from flour having gluten, in embodiments high-gluten flour, into the cooking pouches 106. In embodiments, the system 300 includes a system control 304 that sequences the actuation of the batter applicator 316 to deposit the predetermined quantities of the batter 102 to the pouches before the uncooked protein pieces 8 are placed in the pouches 106 of the packaging machine 320.

In other embodiments, the batter applicator 316 is actuated by the system control 304 to deposit the predetermined quantities of the batter 102 after the uncooked protein pieces 8 are placed in the pouches 106. In still other embodiments, the system control 304 actuates the batter applicator 316 to deposit a first quantity of the batter 102, which is a portion of the total predetermined quantity of the batter, to the pouches 106, then the crust-frozen, uncooked protein pieces 8 are placed in the pouches, then a second quantity, which is the remainder of the predetermined quantity of the batter, is deposited in the pouches by the batter applicator 316. In still other embodiments, the system control 304 actuates the batter applicator 316 to deposit the batter 102 into the pouches 106 with, or at the same time as, the uncooked protein pieces 8. In embodiments, the batter applicator 316 deposits the batter 102 directly into the pouches 106. That is, the batter 102 flows from the batter applicator 316 into the pouches 106 without first being applied to the uncooked protein pieces 8, which already may be in the pouches, or being deposited into another vessel or onto another object, although the batter can flow through a pipe, flexible tube, channel, or nozzle, such as a spray nozzle, between the batter applicator and the pouches.

In embodiments, the batter applicator 316 is selected from a hot pour filling system manufactured by Hinds Bock Corp. of Bothell, Wash.; a volumetric piston filler manufactured by All-Fill Inc. of Exton, Pa.; a servo-driven high-speed piston depositor manufactured by Unifiller Systems Inc. of Delta, British Columbia, Canada; and a hand depositing nozzle filling system manufactured by Unifiller Inc. In embodiments, the packaging machine 320 is programmed, for example by the system control 304, to seal, for example by heat sealing, the crust-frozen, uncooked protein pieces 110 coated with the batter 102 in the cooking pouches 106, and in particular, vacuum seal the pouches.

In exemplary embodiments, the freezer unit 303 is programmed, for example by the system control 304, to crust-freeze the unbattered, uncooked protein pieces 8 to a temperature and a depth sufficient to impart dimensional stability to the protein pieces as they are received in the plastic pouches 106 in the packaging machine 320. The advantage of crust freezing the protein pieces 8 is that crust freezing gives the protein pieces dimensional stability so that they retain their shape as they are conveyed by conveyor 303 and placed in the pouches 106, and as they are coated with batter 102. In embodiments, the system control 304 is a unitary control that sequences and actuates all the components of the system 300. In other embodiments, the system control 304 takes the form of a group of controls associated with two or more components of the system 300, and are interconnected by and/or communicate over a network, either by wire or wirelessly.

As used herein, the term “dimensional stability” means that the crust-frozen protein pieces 8 are sufficiently rigid to retain their overall shape and original dimensions as received by the system 300. This crust-freeze treatment by the freezer unit 302 is especially beneficial when processing protein pieces 8 in the form of boneless chicken breasts, strips, nuggets, tenders, and chunks, fish filets, and sliced beef. By retaining their original shape and dimensions, the crust-frozen, uncooked protein pieces 8 do not fold on themselves or form a bolus during processing by the system 300, including when placed into the pouches 106, but rather retain their pre-processing shape and become coated with the high-gluten batter 102 more evenly and completely when contacted by the high-gluten batter in the pouches, and subsequently during the vacuum sealing process of the pouches by the packaging machine 320.

In exemplary embodiments of the system 300, the batter applicator 316 takes the form of a volumetric portioner that is programmed, for example by system control 304, to deposit a preselected volume of the batter 102 for coating each of the uncooked protein pieces 8 in the pouches 106, either before, after, both before and after, or simultaneously with placing the uncooked protein pieces 8 in the pouches, before the pouches are sealed. Also in exemplary embodiments, the packaging machine 320 is a thermoforming packaging machine that vacuum seals the uncooked protein pieces 8 coated with the batter 102 from the volumetric portioner 316 in the pouches 106.

In other embodiments of the system 300, the batter applicator 316 is programmed, for example by system control 304, to add a first portion of the preselected volume of the batter 102 to the pouches 106 before the cooking pouches receive the crust-frozen, uncooked protein pieces 8, then add a remaining portion of the preselected volume of the batter to the pouches after the cooking pouches receive the uncooked protein pieces.

In an embodiment, the system 300 coats the uncooked protein pieces 8 in the pouches 106 with a coating from the batter applicator 316 consisting of the batter 102 made from high-gluten flour as described previously. In an exemplary embodiment, when the packaging machine 320 seals the pouches 106, the sealed pouches 108 contain only protein pieces 8 coated with the batter 102; the batter does not include breading or other coating material applied to the outer surface of the batter at this time. In further embodiments, the uncooked protein pieces 8 in the cooking pouches 106 are coated with a batter 102 from the batter applicator 316 consisting of a batter made from flour containing gluten and mixed with seasoning. The seasoning may be injected or added to the batter 102 in the batter applicator 316 from a seasoning applicator 312A, or added to the batter mixer 18, which mixes the batter and conveys it to the batter applicator.

In embodiments, the system 300 further includes a heating unit 338 that receives the sealed pouches 108 (see FIG. 2) containing the uncooked protein pieces 8 coated with the batter 102 from the packaging machine 320 and cooks the battered protein pieces in the sealed pouches 108. The heating unit 338 is programmed, for example by system controller 304, to cook the battered protein pieces 100 in the sealed cooking pouches 108 at a temperature and for a time interval selected to completely cook the protein pieces and leave the batter 102 sufficiently tacky to adhere to breading, in other words, below the temperature and time combination that would harden the batter 102 of the battered protein pieces 100 so that it could not adhere to breading. In embodiments, the heating unit 338 sous vide cooks the battered protein pieces 100 in the sealed pouches 108.

In an exemplary embodiment, the system 300 optionally includes a pre-dust unit 312 that receives the protein pieces 8 in an unfrozen, uncooked, and unbattered state and applies a dry particulate coating to outer surfaces thereof. In embodiments, the dry particulate coating is selected from flour, starch, an absorbent, spices, and combinations of the foregoing. The optional freezer unit 302 receives the protein pieces 8 in an unfrozen, uncooked state, optionally pre-dusted with the dry particulate coating from the pre-dust unit 312, either manually, or by conveyor 305.

In embodiments, the optional seasoning applicator 312A applies seasoning to the uncooked protein pieces 8 at one or more of after the pre-dust unit applies the dry particulate coating, for example on conveyor 305, after the freezer unit 302 crust-freezes the protein pieces, for example on conveyor 303, and to the batter 102 in the batter applicator 316 and/or batter mixer 18. In these embodiments, the seasoning applicator 312A applies seasoning to the uncooked protein pieces 8 prior to their being coated with the batter 102 in the pouches 106 in the packaging machine 320.

In sum, the system 300 for processing pieces of protein 8 includes a freezer unit 302 that receives the protein pieces in an unfrozen, uncooked state and optionally retains the unfrozen, uncooked protein pieces at a temperature and for a time interval to crust freeze the uncooked protein pieces to a depth sufficient to impart dimensional stability to the uncooked protein pieces; a packaging machine 320 that receives the crust-frozen, uncooked protein pieces from the freezer unit and retains the crust-frozen, uncooked protein pieces in cooking pouches 106; and a batter applicator 316 that deposits a batter 102 made from flour containing gluten in the cooking pouches to coat outer surfaces of the crust-frozen, uncooked protein pieces. The packaging machine 320 is programmed, for example by system control 304, to vacuum seal the crust-frozen, uncooked protein pieces 100 coated with the batter in the cooking pouches 108. The heating unit 338 is programmed to sous vide cook the battered, uncooked protein pieces 100 in the vacuum sealed cooking pouches 108 for a time and temperature selected to completely cook the protein pieces and leave the batter sufficiently tacky to adhere to breading.

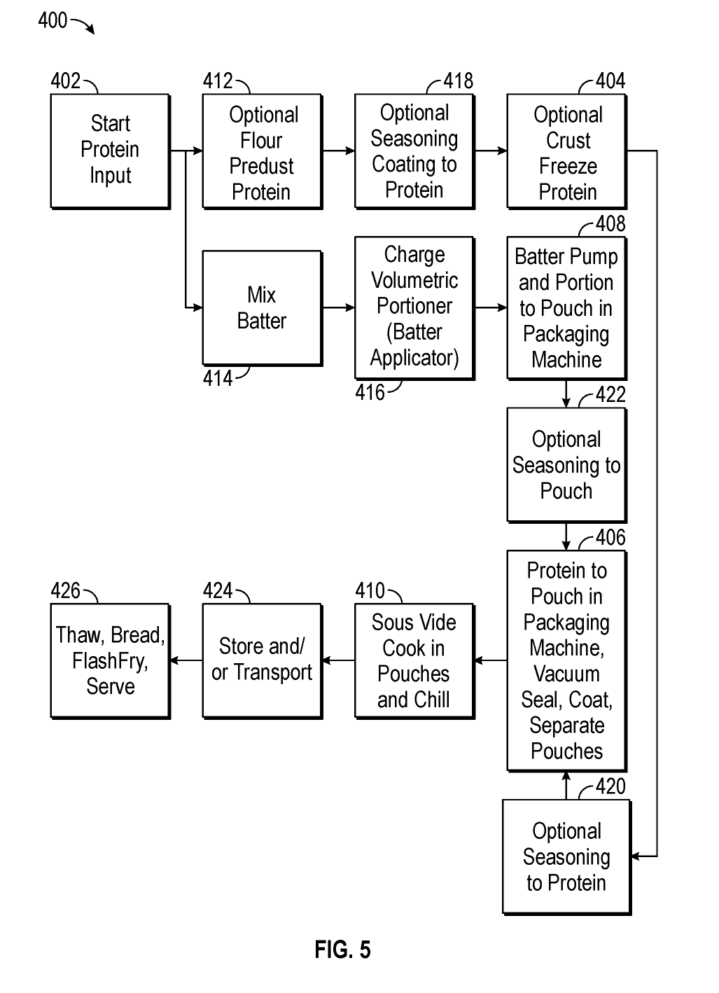

As shown in FIG. 5, an exemplary method for processing pieces of protein 8, generally designated 400, begins with receiving the protein pieces in an unfrozen, uncooked state as indicated in block 402. The protein pieces 8 are placed in or conveyed into the freezer unit 302, as indicated in block 404, where they are crust frozen. The crust-frozen, uncooked protein pieces 8 are conveyed from the freezer unit 302 to and placed in cooking pouches 106, formed by the thermoforming packaging machine 320, as indicated in block 406. As indicated in block 408, a batter made from high-gluten flour is deposited into the pouches 106.

In embodiments, predetermined volumes of the batter 102 are first deposited into the pouches 106 by the batter applicator 316, then the uncooked, optionally crust-frozen protein pieces 8 are placed into the pouches, either singly in each pouch or in groups. In other embodiments, the uncooked protein pieces 8 are first placed in the pouches 106, either singly or in groups, then predetermined volumes of the batter 102 are deposited into the pouches. In still other embodiments, a first portion of the predetermined volume of the batter 102 is deposited in each of the pouches 106, then one or more uncooked, optionally crust-frozen protein pieces 8 are placed into each of the pouches, then a second remaining portion of the predetermined volume of the batter 102 is deposited into each of the pouches. This two-step application of batter 102 to the pouches 106 provides a more even and thorough coating of the outer surfaces of the protein pieces 8 with batter. In still other embodiments, the predetermined volume of batter 102 is deposited into the pouches 106 simultaneously with depositing the protein pieces 8.

As indicated in block 406, the packaging machine 320 vacuum seals the uncooked, optionally crust-frozen protein pieces 8 coated with the batter 102 in the pouches 108. The vacuum seal process facilitates the even and complete coating of the outer surfaces of the uncooked protein pieces 8 in the pouches 106. In an embodiment, in block 404, optionally crust-freezing the protein pieces 8 includes crust freezing the protein pieces sufficiently to impart dimensional stability to the uncooked protein pieces as the crust-frozen, uncooked protein pieces are placed in the cooking pouches 106.

As indicated in block 410, the battered protein pieces, in sealed pouches 108, are completely cooked in the heating unit 338 for a selected time and temperature that leaves the batter 102 sufficiently tacky to adhere to breading after cooking. In embodiments, this step also includes chilling the sealed pouches 108 of fully cooked, battered protein pieces, which is sufficient to stop the cooking process and maintain the tackiness of the batter 102 coating the protein pieces.

As is also shown in FIG. 5, the process 400 in embodiments includes a pre-dust of the protein pieces, indicated in block 412. In embodiments, if optional crust-freezing is employed as indicated in block 404, the pre-dust occurs prior to the crust freezing and is effected by the pre-dust applicator 312 shown in FIG. 4. At the same time, as indicated in block 414, batter mixer 18 (FIGS. 1 and 4) mixes the batter 102 that is charged into batter applicator 316, as indicated in block 416. Optionally, as indicated in blocks 418, 420, and 422, a seasoning applicator 312A adds seasoning to the protein pieces 8 before the optional crust freeze step of block 404 (block 418), and/or after optional crust freezing the protein pieces before the protein pieces are placed in pouches 106 (block 420), indicated in block 206, and/or is added to the batter before it is deposited in the pouches (block 422).

After the protein pieces 8, sealed in pouches 108, are sous vide cooked, as indicated in block 410, the cooked, battered protein pieces 110 in pouches are stored chilled or frozen, and/or are transported to an end user, as indicated in block 424. As indicated in block 426, the cooked battered protein pieces 110 in the sealed pouches 108 are thawed, if necessary, then the cooked and battered protein pieces, in which the batter is now tacky, are removed from their pouches 106. At this time the cooked battered protein pieces 110 may be breaded with a breading of choice by a food preparer, flash fried, and served.

As shown in FIG. 4, in embodiments the system 300 takes the form of a food processing line for processing pieces of protein. The food processing line includes an environmentally separated preparation room 60 enclosing the freezer unit 302 that receives the protein pieces 8 in an unfrozen, uncooked state and optionally crust freezes the protein pieces. Room 60 also includes the packaging machine 320 that is connected to receive the optionally crust-frozen, uncooked protein pieces 8 from the freezer unit 302 and retain the uncooked protein pieces in pouches 106, and the batter applicator 316 that deposits the batter 102 made from flour containing gluten directly into the pouches. The packaging machine 320 is programmed, for example by system control 304, to seal the uncooked protein pieces 8 coated with the batter in the cooking pouches 108. This sealing by the packaging machine 320 in embodiments is vacuum sealing, which causes the batter 102 to flow around the protein pieces 8 and coat the outer surfaces thereof.

In embodiments, the environmentally isolated preparation room 60 includes the seasoning applicator 312A that applies seasoning to the outer surfaces of the uncooked protein pieces 8, and the pre-dust unit 312 that receives the protein pieces 8 in an uncooked, unfrozen, and unbattered state and applies a dry particulate coating to outer surfaces thereof. The optional freezer unit 302 receives the protein pieces in an uncooked state with the dry particulate coating from the pre-dust unit 312. The preparation room 60 also includes the batter mixer 18 for making the batter made from high-gluten flour, which is connected to deliver batter to the batter applicator 316.

In embodiments, the system 300 also includes an environmentally isolated cooking room 62 that contains the heating unit 338 that receives the sealed pouches 108 from the packaging machine 320 in the preparation room and cooks the battered pieces of protein 8 in the cooking pouches. In embodiments, the system 300 also includes an environmentally isolated cold room 64 containing the cold storage 342 for chilling the cooking pouches 108 of cooked, battered pieces of protein.

The components of the system 300 are connected by a first conveyor, which may take the form of conveyor 303, for conveying the uncooked, optionally crust-frozen protein pieces 8 from the freezer unit 302 to the packaging machine 320 in the preparation room; a second conveyor, which may take the form of conveyor 344 for conveying the protein pieces sealed in pouches 108 from the packaging machine 320 in the preparation room 60 to the heating unit 338 in the cooking room 62; and a third conveyor, which may take the form of conveyor 346, for conveying the cooked, battered protein pieces 110 sealed in the cooking pouches 108 from the heating unit in the cooking room to the cold storage in the environmentally separated cold room 64. Optionally, freezer unit 302 receives unfrozen, uncooked protein pieces 8 from the pre-dust unit 312 by way of a fifth conveyor, which may take the form of conveyor 305. In other embodiments, the freezer unit 302 is not employed, and the protein pieces 8 are conveyed by conveyors 305, 030 to the packaging machine 320. In still other embodiments, uncooked protein pieces 8 are placed in pouches 106 of the packaging machine 320 without a pre-dust of flour from the flour applicator 312 and/or without the addition of seasoning from the seasoning applicator 312A.

In embodiments, the food processing line of system 300, the pre-dust unit 312, the optional freezer unit 302, and the packaging machine 320 are series connected; and the heating unit 338 is series connected to the packaging machine. Also in embodiments, the batter applicator 316 is directly series connected to the packaging machine 320, and the batter mixer 18 is series connected to the batter applicator 316.

The system 300 provides a method for processing protein pieces 8 in which battered, pre-cooked protein pieces are vacuum sealed in pouches 108 that may be transported for later use, in which the cooking time and temperature are selected such that the protein pieces are thoroughly cooked and the batter 102 remains sufficiently tacky when the cooked battered protein pieces 110 are removed from the pouches to accept breading or other coating. By optionally crust freezing the uncooked, unbattered protein pieces 8, the protein pieces are made dimensionally stable, which facilitates their insertion into pouches 106 in which the batter 102 is deposited, and promotes formation of a uniform, even, and complete coating of batter on each individual protein piece, while at the same time increasing the throughput rate of protein pieces through the system 3000, and minimizing waste of batter.

While the forms of apparatus and methods described herein constitute preferred embodiments of the disclosed system and process for cooking pieces of protein, it is to be understood that the disclosure is not limited to these precise systems and methods, and that changes may be made therein without departing from the scope of the disclosure.

What is claimed is:

1. A system for processing pieces of protein, the system comprising:
a packaging machine that receives uncooked protein pieces and retains the uncooked protein pieces in pouches;
a batter applicator that deposits a batter made from flour containing gluten into the pouches; and
the packaging machine programmed to seal the uncooked protein pieces in the pouches, thereby coating the uncooked protein pieces with the batter, forming coated, uncooked protein pieces.

2. The system of claim 1, wherein the packaging machine vacuum seals the coated, uncooked protein pieces in the pouches.

3. The system of claim 1, wherein the packaging machine is a thermoforming packaging machine.

4. The system of claim 1, wherein the batter applicator is a volumetric portioner that is programmed to deposit a preselected volume of the batter directly into the pouches to coat each of the uncooked protein pieces in the pouches; and wherein the packaging machine is a thermoforming packaging machine that vacuum seals the uncooked protein pieces coated with the batter from the volumetric portioner in the pouches.

5. The system of claim 4, wherein the batter applicator is programmed to deposit a first portion of the preselected volume of the batter into the pouches before the pouches receive the uncooked protein pieces, then deposit a remaining portion of the preselected volume of the batter into the pouches after the pouches receive the uncooked protein pieces.

6. The system of claim 1, wherein the batter applicator is programmed to deposit the batter into the pouches either before the pouches receive the uncooked protein pieces, after the pouches receive the uncooked protein pieces, or as the pouches receive the uncooked protein pieces.

7. The system of claim 1, wherein the batter applicator is programmed to deposit the batter directly into the pouches.

8. The system of claim 1, further comprising a heating unit that receives the sealed pouches containing the protein pieces coated with the batter from the packaging machine and cooks the battered protein pieces in the pouches.

9. The system of claim 8, wherein the heating unit is programmed to cook the battered protein pieces in the pouches at a temperature and for a time interval selected to completely cook the protein pieces and leave the batter sufficiently tacky such that breading can adhere thereto.

10. The system of claim 9, wherein the heating unit sous vide cooks the battered protein pieces in the cooking pouches.

11. The system of claim 1, further comprising a pre-dust unit that receives the protein pieces in an uncooked and unbattered state and applies a dry particulate coating to outer surfaces thereof.

12. The system of claim 11, wherein the dry particulate coating is selected from flour, starch, an absorbent, spices, and combinations of the foregoing.

13. The system of claim 11, further comprising a seasoning applicator that applies seasoning to the uncooked protein pieces at one or more of after the pre-dust unit applies the dry particulate coating, and to the batter from the batter applicator.

14. The system of claim 1, wherein the batter applicator deposits a batter made from flour containing gluten and water, and optionally egg white, egg, milk, buttermilk, seasonings, soy, fish meal, meat-meal, nut meal, legume-flour, pea-flour, and mixtures of the foregoing.

15. The system of claim 1 further comprising a seasoning applicator that applies seasoning to the uncooked protein pieces prior to application of the batter to the uncooked protein pieces.

16. A system for processing pieces of protein, the system comprising:
an optional flour applicator that applies a coating of flour, and optionally seasoning, to uncooked protein pieces;
an optional seasoning applicator that applies a coating of seasoning on the uncooked protein pieces;
a packaging machine that receives uncooked protein pieces, optionally coated with flour and/or seasoning, and retains the optionally coated, uncooked protein pieces in pouches;
a batter applicator that deposits a batter made from a flour containing gluten directly into the pouches;
the packaging machine programmed to vacuum seal the optionally coated, uncooked protein pieces, thereby coating the optionally coated, uncooked protein pieces with the batter in the pouches to make batter-coated uncooked protein pieces; and
a heating unit programmed to sous vide cook the batter-coated, uncooked protein pieces in the cooking pouches for a time and temperature selected to completely cook the protein pieces and leave the batter sufficiently tacky to adhere to breading.

17. A method for processing protein pieces, the method comprising:
placing uncooked protein pieces in pouches;
depositing a batter made from flour containing gluten, and optionally egg, milk, buttermilk, seasonings, soy or fish meal, meat-meal, nut meal, legume-flour, pea-flour or mixtures thereof, in the cooking pouches either before or after placing the uncooked protein pieces in the cooking pouches; and
sealing the uncooked protein pieces in the pouches, thereby resulting in coated uncooked protein pieces.

18. The method of claim 17, further comprising completely cooking the sealed battered uncooked protein pieces, while in the sealed pouches, at a temperature and time selected to completely cook the protein pieces, whereby the batter is sufficiently tacky such that breading can adhere thereto.

19. The method of claim 17, wherein depositing the batter includes depositing a preselected volume of the batter, wherein a first portion of the preselected volume of the batter is added to the pouches before the pouches receive the uncooked protein pieces, and then a remaining portion of the preselected volume of the batter is added to the pouches after the pouches receive the uncooked protein pieces.

20. The method of claim 17, further comprising applying a coating to outer surfaces of uncooked protein pieces, the coating consisting of flour optionally mixed with spices, resulting in coated uncooked protein pieces, prior to placing the uncooked protein pieces in cooking pouches.

21. A food processing line for processing pieces of protein, the processing line comprising:
a packaging machine in an environmentally separated preparation room that receives uncooked protein pieces and retains the uncooked protein pieces in pouches, and a batter applicator that deposits a batter made from flour containing gluten directly into the pouches, wherein the packaging machine is programmed to seal the uncooked protein pieces, thereby forming battered uncooked protein pieces sealed in the pouches; and
an environmentally separated cooking room containing a heating unit that receives the sealed cooking pouches from the packaging machine and completely cooks the battered pieces of protein while in the pouches at a temperature and time selected to completely cook the protein pieces, whereby the batter is sufficiently tacky such that breading can adhere thereto.

22. The food processing line of claim 21, wherein the preparation room includes a seasoning applicator that applies seasoning to the outer surfaces of the uncooked protein pieces.

23. The food processing line of claim 22, wherein the preparation room includes a pre-dust unit that receives the protein pieces in an uncooked and unbattered state and applies a dry particulate coating to outer surfaces thereof.

24. The food processing line of claim 23, wherein the pre-dust unit applies flour selected from all-purpose flour, rice flour, pea flour, sorghum flour, high-gluten wheat flour, high-protein wheat flour, nut flour, soy powder, milk powder, whey powder, and mixtures thereof.

25. The food processing line of claim 24, wherein the preparation room includes a batter mixer for making the batter, and the batter applicator is connected to receive the batter from the batter mixer.

26. The food processing line of claim 25, further comprising an environmentally separated cold room containing a cold storage for chilling the pouches of cooked, battered pieces of protein.

27. The food processing line of claim 25, further comprising a first conveyor for conveying the uncooked protein pieces from the freezer unit to the packaging machine in the preparation room; a second conveyor for conveying the pieces of protein sealed in pouches from the packaging machine in the preparation room to the heating unit in the cooking room; and a third conveyor for conveying the cooked, battered protein pieces sealed in the pouches from the heating unit in the cooking room to the cold storage in the environmentally separated cold room.

28. The food processing line of claim 23, wherein the pre-dust unit, the freezer unit and the packaging machine are series connected; and the heating unit is series connected to the packaging machine.

29. The food processing line of claim 28, wherein the batter applicator is series connected to the packaging machine.

30. The food packaging machine of claim 29, further comprising a batter mixer for mixing the high-gluten flour; and wherein the batter mixer is series connected to the batter applicator.
